(19) United States
(12) Patent Application Publication
(10) Pub. No.: US 2024/0279976 A1
(43) Pub. Date: Aug. 22, 2024

(54) METHOD FOR OPERATING AN ADJUSTMENT DEVICE FOR AT LEAST ONE VEHICLE PART OF A VEHICLE THAT CAN BE ADJUSTED BY MEANS OF AN ELECTRICAL DRIVE, SAID ADJUSTMENT DEVICE HAVING A CENTRAL CONTROL UNIT AND AT LEAST ONE LOCAL CONTROL UNIT

(71) Applicant: Conti Temic microelectronic GmbH, Ingolstadt (DE)

(72) Inventors: Michael Beuschel, Stammham (DE); Stefan Bauer, Engelbrechtsmünster (DE)

(73) Assignee: Conti Temic microelectronic GmbH, Ingolstadt (DE)

(21) Appl. No.: 18/682,881

(22) PCT Filed: Jul. 26, 2022
(86) PCT No.: PCT/DE2022/200168

§ 371 Date: Feb. 9, 2024

(30) Foreign Application Priority Data
Aug. 10, 2021 (DE) 10 2021 208 730.2

(51) Int. Cl. E05F 15/41; B60R 16/023; E05F 15/695

(52) U.S. Cl. CPC E05F 15/41; E05F 15/695; B60R 16/0231; E05Y 2400/32; E05Y 2400/652; E05Y 2400/66; E05Y 2900/55

(57) ABSTRACT

An adjustment device for a vehicle part of a vehicle that can be adjusted comprises a central control unit and a local control unit connected via a communication interface to the central control unit, and directly activates the electrical drive for stopping or reversing an adjustment process upon a specified pinching criterion. The central control unit transmits a triggering threshold value for the operating variable to a respective local control unit with an adjustment request for the vehicle part, and a reaction to be triggered upon reaching the triggering threshold value. The central control unit, as necessary, transmits new values to the respective local control unit during the adjustment process. The local control unit compares the determined values of the operating variable to the current triggering threshold value(s) and independently triggers the reaction transmitted when an operating variable exceeds or falls below the assigned current triggering threshold value.

Mechanically actuatable adjustment devices, such as window lifters, seat adjustment devices, sliding roofs, rear hatches, or doors having electric drives are increasingly being equipped in vehicles. Since these drives can apply significant forces under certain circumstances, an overload protection or a pinch detector is used here to avoid damage to people and vehicle components.

Such a pinch detector requires variable triggering threshold values, since in the case of, for example, pinched limbs, the movement of the adjustment device has to be rapidly stopped or reversed even with low forces, whereas when retracting an adjustment device into an end position (for example, end stop, seal) it only has to be switched off at a higher force (blocking) or after a longer force action.

In particular in the case of adjustment devices having hard edges, such as windows or sliding roofs, pinching has to be reacted to in a time window of 1 to 5 ms, also due to legal specifications.

Therefore, a measuring device, a device for evaluating exceeding or falling below triggering thresholds, and a logic for defining the reaction to be triggered are typically located in the same control unit, usually close to the drive, to which the drive is directly electrically connected.

DE 10 2016 224 539 A1 describes a pinch detector having variable triggering threshold values which are adapted depending on driving states, such as rough roads. The driving states are determined via operating data of the vehicle, such as the speed, or by sensor devices for observing the surroundings, such as a camera.

DE 10 2018 202 784 A1 describes a concept for using common parts in local control units for the pinch detector of different door actuators. Multiple parameter sets are stored in a nonvolatile manner in each case in local control units. A central control unit then provides a signal in operation to select the respective required parameter set.

New vehicle architectures permit increasingly complex links between various functions in the vehicle; this is preferably carried out in central control units in order to reduce the communication expenditure in comparison to a decentralized solution.

A higher level of functional complexity also requires more frequent software updates, which may also be downloaded more easily onto a central control unit than a software distribution onto additional decentralized control units. There is therefore the desire to also be able to control and update a blocking detector centrally; this also includes the above-mentioned pinch detector.

At the same time, however, commercially-available communication interfaces, such as the LIN or CAN bus, are too slow or, because of the requirement of transmitting analog signals via a large number of lines, are too complex for an evaluation of the pinch detection in the central control unit and subsequent request for a rapid reaction at the decentralized drive.

The object of the invention is to specify a method for operating an adjustment device for at least one vehicle part of a vehicle that can be adjusted by means of an electrical drive, said adjustment device having a central control unit and at least one local control unit, in which the local control unit close to the drive is to manage without updates for software or parameters and nonetheless is to enable a rapid reaction to cases of pinching.

The object is achieved by a method for operating an adjustment device for at least one vehicle part of a vehicle that can be adjusted by means of an electrical drive, said adjustment device having a central control unit and at least one local control unit, wherein a respective local control unit acts directly on the electrical drive assigned thereto and is connected via a communication interface to the central control unit, wherein during an adjustment process carried out by means of the adjustment device, at least one operating variable of the vehicle part that can be adjusted is detected by means of at least one sensor, and wherein each local control unit activates the electrical drive assigned thereto in the context of a pinch protection function for stopping or reversing an adjustment process if a specified pinching criterion is met. The central control unit transmits at least one triggering threshold value for the at least one operating variable and a reaction to be triggered upon reaching the triggering threshold value to a respective local control unit via the communication interface with an adjustment request for the vehicle part that can be adjusted, wherein the central control unit if necessary transmits at least one new triggering threshold value and/or at least one new reaction and/or a new adjustment request to the respective local control unit during the adjustment process. A respective local control unit compares the determined values of the at least one operating variable to the current triggering threshold value(s) and independently triggers the reaction transmitted from the central control unit if at least one operating variable exceeds or falls below the assigned current triggering threshold value.

The local control unit only contains a comparatively simple logic or functionality, which does not have to be updated, and can therefore be produced cost-effectively. The reaction time due to the communication between local and central control units (outgoing and return journeys) is not safety-critical for limiting the maximum pinching and blocking forces and can therefore be designed to be cost-effective and comparatively slow (for example, LIN bus).

The system can nonetheless be operated with a complex logic or functionality, wherein the central control unit can also use information for calculating the specified values, which are not visible at all in the local control unit (e.g., driving status, environmental conditions, statuses of other control units).

In particular, such a system allows an interaction or coordination of the triggering thresholds and reactions over multiple actuators, which are operated by different local control units (for example, parts to be moved toward one another such as seat and steering column or front and rear seats).

Due to the availability of the data from multiple local control units in a central (external) control unit or server, automatic corrections and adaptations can be carried out. Thus, for example, wear-dependent effects can be detected and the triggering thresholds can thus be adopted in all connected local control units.

The complex logic or functionality of the system can be updated or adapted in a simple manner in the central control unit (for example, “over-the-air update”), without further distribution of the data to lower-level local control units being required.

In the method according to the invention, an adjustment request can be a target position or a target movement direction of a vehicle part that can be adjusted.

In one embodiment of the invention, the local control unit stores the respective transmitted triggering threshold value and the associated reaction in a volatile memory.

The expenditure for a changeable nonvolatile memory for changing triggering threshold values and reactions to be triggered is thus dispensed with.

In a further embodiment of the invention, the communication interface has a communication delay which is greater than the permissible maximum reaction time in the case of the operating variable exceeding or falling below the current triggering threshold value.

In still a further embodiment of the invention, the communication interface has a communication delay which is less than the shortest interval between two changes of the triggering threshold value and/or the reaction and/or the adjustment request.

In one refinement of the invention, the adjustment request, on the one hand, and the first triggering threshold value and the associated reaction to be triggered, on the other hand, are transmitted in a common communication message from the central control unit to the local control unit or in separate messages asynchronous to one another.

In a further refinement of the invention, the central control unit transmits a target movement direction to the local control unit, the local control unit returns at regular intervals the actual position of the vehicle part that can be adjusted to the central control unit, which then transmits a signal to stop to the local control unit at a suitable time.

A positioning logic can be designed in the central control unit in this case. In this way, this can also be easily adapted by updates.

In still a further refinement of the invention, the triggering threshold value can relate to directly measured or indirectly determined variables.

The directly measured or indirectly determined variables can be, for example, a force excess, a motor current, a power consumption, a speed change, an acceleration, or a temperature. Multiple triggering threshold values can also be used for different variables, for example, force and temperature as alternative shutdown thresholds.

In one refinement, the requested reaction in the case of a triggering also includes, in addition to immediate stopping or reversing of the drive, a waiting time, a specified period of time, or a position change for reversing.

A completely autonomous reaction by the local control unit would thus be possible without new exchange of communication data between both control units after a triggering.

In another refinement, the data transmitted from the central control unit to the local control unit also include further specified values for the adjustment process.

The local control unit can thus run movement profiles independently, wherein the characteristics remain specifiable by the central control unit in each case.

In another refinement, the data transmitted from the central control unit to the local control unit also contain parameters for processing the measured signals, such as correction values, offsets, filter parameters for smoothing triggering-relevant signals or for suppressing undesired frequency ranges. These can be, for example, vibrations on rough roads.

In a further refinement, the determination of the triggering threshold value and the reaction to be triggered also takes place outside the vehicle on a central server.

This can be performed, for example, by means of a radio connection, for example, by means of an antenna. In this way, measurement data from different vehicles can be evaluated and used jointly for future adjustment processes.

The invention will be described in greater detail below on the basis of an exemplary embodiment with the aid of figures. In the figures,

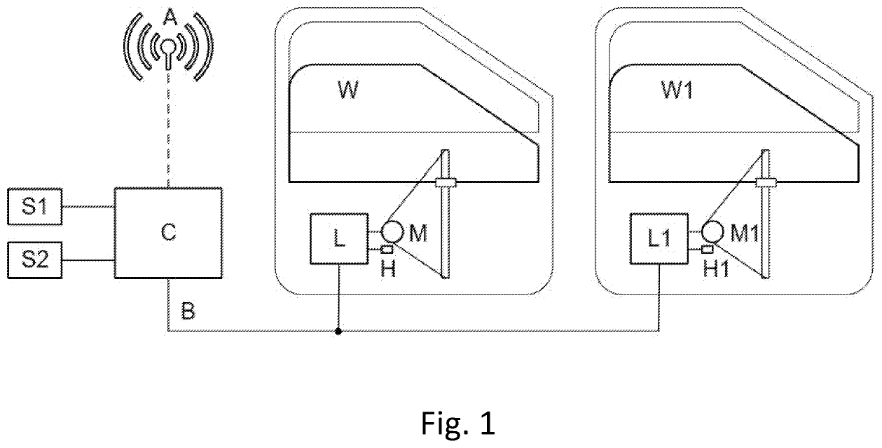

FIG. 1 shows a schematic illustration of an adjustment device and

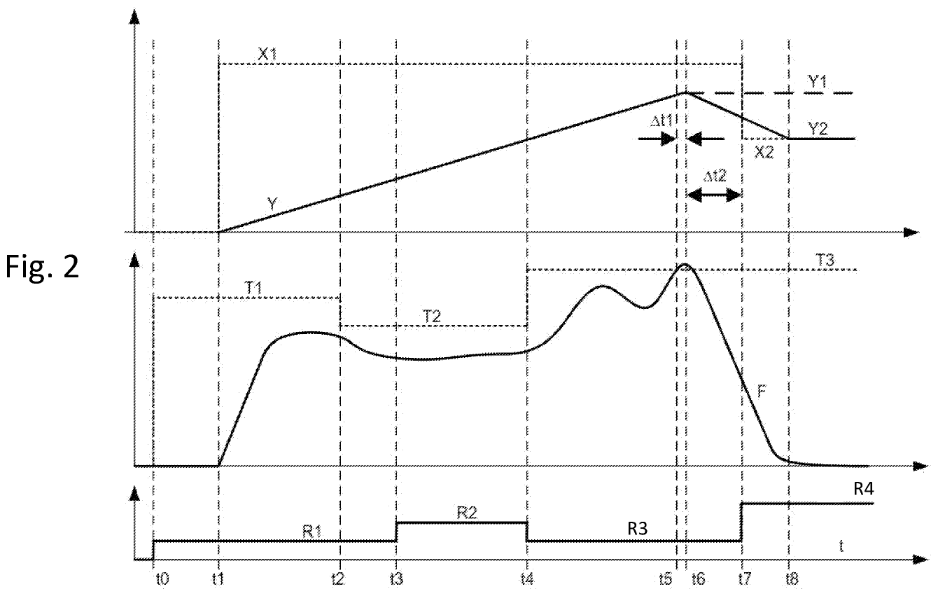

FIG. 2 shows a time profile of a possible adjustment process.

FIG. 1 shows an adjustment device, which is formed having a first local control unit L and a second local control unit L1, which respectively activate a motor M or M1 for actuating a vehicle part W or W1 that can be adjusted (such as a window). To indirectly detect a pinching force F, the local control units L, L1 additionally input the values of a Hall sensor H or H1 or alternatively a current measurement (not shown). Position information of the drive is typically also determined from such sensor data.

Only two local control units L, L1 are shown, however, there can also be still further control units in the scope of the invention which can also activate other types of vehicle parts that can be adjusted such as sliding roofs, doors, rear hatches, etc.

Moreover, the system has a central control unit C, which communicates via a communication interface in the form of a communication bus B with the local control unit L, L1. The central control unit optionally also acquires data of further sensors S1, S2 on vehicle statuses or can moreover communicate via an antenna A with a server (not shown). The central control unit C can communicate with multiple local control units L, L1, which actuate multiple adjustment devices W, W1.

A possible time profile of an adjustment process is shown in FIG. 2. In this case, X1, X2 specifies a target position of the drive or the vehicle part that can be adjusted and Y specifies its actual position. Furthermore, the measured or determined pinching force F and associated triggering threshold values T1, T2, T3 are shown. Finally, various specified reactions R1, R2, R3 to a pinching event, which is defined by exceeding a triggering threshold value T1, T2, T3, are shown.

The following events are shown in FIG. 2 in the time profile at points in time t0 to t8 and will be explained hereinafter:
t0: The central control unit C transmits a first triggering threshold value T1 and an associated reaction R1 (for example reversing) to the local control unit L or L1; this stores both for a following adjustment process.
t1: The central control unit C transmits a first target position X1 to the local control unit L or L1 and thus starts the adjustment process.
t2: The central control unit C transmits a new second triggering threshold value T2 to the local control unit L or L1; this stores the new second value T2 instead of the previous first value T1 for the further adjustment process.
t3: The central control unit C transmits a new second reaction R2 (for example immediate stopping) to the local control unit L or L1; this stores the new second reaction R2 instead of the first reaction R1 for the further adjustment process.
t4: The central control unit C transmits both a new third triggering threshold value T3 and a new third reaction R3, which corresponds in its content to the first reaction R1 (for example reversing), to the local control unit L or L1; this stores the new third reaction R3 instead of the previous second reaction R2 for the further adjustment process.
t5: The local control unit L or L1 detects exceeding of the measured pinching force F via the current third triggering threshold value T3.
t6: The local control unit L or L1 reverses the drive in accordance with the last requested third reaction R3. Only the short period of time Δt1 has passed between detection and reaction. Moreover, the local control unit L or L1 transmits a message to the central control unit C that triggering was detected and reversing has taken place.
t7: The central control unit C only transmits a new second target position X2 and a new fourth reaction R4 (for example, no reaction upon exceeding the triggering threshold value) after a longer period of time Δt2 (which is still sufficient for this purpose).
t8: The actual position Y2 of the drive reaches the second target position X2 and the local control unit L or L1 thereupon stops the drive.

If the specified reaction at the point in time t5 and t6 were “stopping” (instead of “reversing”), the local control unit would have already stopped the drive at the point in time t6 at the actual position Y1 (dashed profile).

The transmission of adjustment request, on the one hand, and triggering threshold value and reaction to be triggered, on the other hand, can take place in a common communication message from the central control unit C to the local control unit L or L1 or also in separate messages asynchronous to one another. These messages are sent at least always in the event of a change of at least one of these values. The communication delay has to be less than the shortest interval between two such changes.

The local control unit L or L1 advantageously returns current measured values of the position and the triggering-relevant variable at regular intervals to the central control unit C. Therefore, triggering threshold values for future adjustment processes can be adapted in the central control unit C in an already known manner in order to map changes via position, service life, or temperature of the drive. For better assignment with a high latency time of the communication, transmitted measured values can additionally be provided with a time stamp or position stamp.

The present invention may preferably be used for controlling electrical window lifters and sliding roofs in vehicles. It is also suitable for electrically actuatable seats, steering wheels, doors, hatches, and the like in the vehicle.

1. A method for operating an adjustment device for at least one vehicle part of a vehicle that can be adjusted by means of an electrical drive, said adjustment device having a central control unit and at least one local control unit, wherein a respective local control unit acts directly on the electrical drive assigned thereto and is connected via a communication interface to the central control unit,
wherein during an adjustment process carried out by means of the adjustment device, at least one operating variable of the vehicle part that can be adjusted is detected by means of at least one sensor,
wherein each local control unit activates the electrical drive assigned thereto in a context of a pinch protection function for stopping or reversing an adjustment process if when a specified pinching criterion is met,
wherein the central control unit transmits at least one triggering threshold value for the at least one operating variable to a respective local control unit via the communication interface with an adjustment request for the vehicle part that can be adjusted, and a reaction to be triggered upon reaching the triggering threshold value,
wherein the central control unit if, when necessary, transmits at least one of a new triggering threshold value, a new reaction, and a new adjustment request to the respective local control unit during the adjustment process, and
wherein a respective local control unit compares the determined values of the at least one operating variable to the current triggering threshold value(s) and independently triggers the reaction transmitted from the central control unit if when at least one operating variable exceeds or falls below the assigned current triggering threshold value.

2. The method as claimed in claim 1, wherein an adjustment request is a target position or a target movement direction of a vehicle part that can be adjusted.

3. The method as claimed in claim 1, in wherein the local control unit stores the respective-transmitted triggering threshold value and an associated reaction in a volatile memory.

4. The method as claimed in claim 1, in wherein the communication interface has a communication delay which is greater than a permissible maximum reaction time for the operating variable exceeding or falling below the current triggering threshold value.

5. The method as claimed in claim 1, wherein the communication interface has a communication delay which is less than the shortest interval between two changes of the at least one of triggering threshold value, the reaction, and the adjustment request.

6. The method as claimed in claim 1, wherein the adjustment request, a combination of a first triggering threshold value and an associated first reaction to be triggered are transmitted in a common communication message or in separate messages asynchronous to one another from the central control unit to the local control unit.

7. The method as claimed in claim 1, wherein when the central control unit transmits a target movement direction to the local control unit, the local control unit returns at regular intervals the actual position of the vehicle part that can be adjusted to the central control unit, which then transmits a signal to stop to the local control unit at a suitable time.

8. The method as claimed in claim 7, wherein a positioning logic is designed in the central control unit.

9. The method as claimed in claim 1, wherein the triggering threshold value relates to directly measured or indirectly determined variables.

10. The method as claimed in claim 1, wherein a requested reaction of a triggering also includes, in addition to immediate stopping or reversing of the drive, a waiting time, a specified period of time, or a position change for reversing.

11. The method as claimed in claim 1, wherein data transmitted from the central control unit to the local control unit also include further specified values for the adjustment process.

12. The method as claimed in claim 1, wherein the data transmitted from the central control unit to the local control unit also contain parameters for processing measured signals such as correction values, offsets, filter parameters for smoothing triggering-relevant signals or for suppressing undesired frequency ranges.

13. The method as claimed in claim 1, wherein the determination of the triggering threshold value and the reaction to be triggered also takes place outside a vehicle on a central server.

14. The method as claimed in claim 2, wherein the local control unit stores the transmitted triggering threshold value and an associated reaction in a volatile memory.

15. The method as claimed in claim 2, wherein the communication interface has a communication delay which is greater than a permissible maximum reaction time for the operating variable exceeding or falling below the current triggering threshold value.

16. The method as claimed in claim 2, wherein the communication interface has a communication delay which is less than the shortest interval between two changes of the at least one of triggering threshold value, the reaction, and the adjustment request.

17. The method as claimed in claim 2, wherein the adjustment request, and a combination of a first triggering threshold value and an associated first reaction to be triggered are transmitted in a common communication message or in separate messages asynchronous to one another from the central control unit to the local control unit.

18. The method as claimed in claim 2, wherein when the central control unit transmits a target movement direction to the local control unit, the local control unit returns at regular intervals the actual position of the vehicle part that can be adjusted to the central control unit, which then transmits a signal to stop to the local control unit at a suitable time.

19. The method as claimed in claim 18, wherein a positioning logic is designed in the central control unit.

20. The method as claimed in claim 2, wherein the triggering threshold value relates to directly measured or indirectly determined variables.
